(19) United States
(12) Patent Application Publication
(10) Pub. No.: US 2026/0342729 A1
(43) Pub. Date: Oct. 29, 2026

(54) 4G CU/DU S1-U Aggregator

(71) Applicant: Parallel Wireless, Inc., Nashua, NH (US)

(72) Inventors: Mahendra Singh Rajput, Nashua, NH (US); David Khemelevsky, Kfar Sava (IL)

(21) Appl. No.: 19/561,474

(22) Filed: Mar. 9, 2026

Related U.S. Application Data
(60) Provisional application No. 63/768,878, filed on Mar. 7, 2025.

(51) Int. Cl. H04L 45/76; H04L 45/74; H04L 45/80

(52) U.S. Cl. CPC H04L 45/76; H04L 45/74; H04L 45/80

(57) ABSTRACT

A method for aggregating S1-U interface traffic in a virtualized baseband unit (vBBU) server is provided. The method includes receiving, at a network connectivity gateway, a downlink packet from a Serving Gateway (SGW), wherein the downlink packet includes a GTP-U header containing a Tunnel Endpoint Identifier (TEID). The method includes extracting a virtual node identifier (vNodeId) from a predetermined bit position within the TEID. The method includes determining, based on the extracted vNodeId, a destination virtual node (vNode) instance from a plurality of vNode instances hosted on the vBBU server. The method includes forwarding the downlink packet to the determined destination vNode instance.

### CROSS-REFERENCE TO RELATED APPLICATIONS

This application is a non-provisional conversion of, and claims priority under 35 U.S.C. § 119(e) to, U.S. Provisional Patent Application No. 63/768,878, filed Mar. 7, 2025 and titled “4G CU/DU S1-U Aggregator,” which is hereby incorporated by reference in its entirety. In addition, this application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; US20230269633A1; and US20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X 2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828427, U.S. Pat. App. Pub. Nos. US20170273134A1, US20170127409A1, US20200128414A1, US20230019380A1 in their entirety. Features and characteristics of and pertaining to the systems and methods described in the present disclosure, including details of the vBBUn nodes and the gateway described herein, are provided in the documents incorporated by reference.

### BACKGROUND

In both second-generation (2G) and third-generation (3G) radio access technologies, a Radio Access Network (RAN) aggregation node is provided with the benefit of reducing the load on the core network. In 2G, this node is the Base Station Controller (BSC), which aggregates traffic from multiple Base Transceiver Stations (BTS) before communicating with the core network. In 3G, the Radio Network Controller (RNC) serves a similar function, managing multiple Node Bs and aggregating their traffic toward the core network elements.

Fifth-generation (5G) technology enables RAN aggregation through the Centralized Unit (CU), which separates control plane and user plane functions and allows for flexible deployment architectures. The CU can aggregate traffic from multiple Distributed Units (DUs), providing efficient management of network resources and reducing the number of interfaces to the core network.

However, fourth-generation (4G) technology, as specified by the Third Generation Partnership Project (3GPP), does not include such an aggregation node in its standard architecture. In 4G Long Term Evolution (LTE) networks, each evolved Node B (eNB) communicates directly with the Evolved Packet Core (EPC) through S1 interfaces, including the S1-U interface for user plane traffic to the Serving Gateway (SGW) and the S1-C interface for control plane traffic to the Mobility Management Entity (MME).

The deployment of virtualized baseband units (vBBU) in 4G networks introduces additional complexity. In virtualized environments, multiple virtual nodes (vNodes) may be deployed on a single server, with each vNode supporting a single sector or carrier. This architecture can result in a large number of IP addresses being required for communication with the core network, as each vNode instance may require its own IP address for S1-U connectivity.

The proliferation of IP addresses in virtualized 4G (and 5G) deployments creates challenges for network operators. Managing numerous IP addresses increases operational complexity, consumes limited IP address resources, and may complicate security and routing configurations. Additionally, the lack of an aggregation mechanism in 4G means that the core network must maintain separate connections to each vNode instance, increasing the load on core network elements.

Therefore, improved systems and methods for aggregating user plane traffic in virtualized network deployments are desired.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for aggregating S1-U interface traffic in a virtualized baseband unit (vBBU) server is provided. The method includes receiving, at a network connectivity gateway, a downlink packet from a Serving Gateway (SGW), wherein the downlink packet includes a GTP-U header containing a Tunnel Endpoint Identifier (TEID). The method includes extracting a virtual node identifier (vNodeId) from a predetermined bit position within the TEID. The method includes determining, based on the extracted vNodeId, a destination virtual node (vNode) instance from a plurality of vNode instances hosted on the vBBU server. The method includes forwarding the downlink packet to the determined destination vNode instance.

According to other aspects of the present disclosure, the method may include one or more of the following features. The predetermined bit position may comprise bits 24-31 of the TEID. The TEID may further encode a Cell identifier (CellId) in bits 20-23, a User Equipment identifier (UE Id) in bits 8-19, a Radio Bearer Identifier (RBID) in bits 2-7, and a Tunnel type in bits 0-1. The method may further include receiving, at the network connectivity gateway, an uplink packet from a vNode instance, replacing a source IP address of the uplink packet with an external S1-U IP address, and transmitting the uplink packet to the SGW. The plurality of vNode instances may share a single external S1-U IP address for communication with the SGW. The method may further include receiving a GTP-U echo request from a vNode instance, wherein the echo request includes a sequence number encoding the vNodeId, and forwarding the echo request to the SGW. The method may further include receiving a GTP-U echo response from the SGW, extracting the vNodeId from the sequence number of the echo response, and forwarding the echo response to the vNode instance corresponding to the extracted vNodeId. The method may further include, during initialization, creating a plurality of internal loopback IP addresses and assigning each loopback IP address to a respective vNode instance. The method may further include receiving a socket bind request from a vNode instance specifying an external IP address, and associating the vNode instance with an internal loopback IP address while mapping the vNode instance to the external IP address.

According to another aspect of the present disclosure, a system for aggregating S1-U interface traffic is provided. The system includes a virtualized baseband unit (vBBU) server hosting a plurality of virtual node (vNode) instances, each vNode instance configured to support at least one cellular sector. The system includes a network connectivity gateway executing on the vBBU server, the network connectivity gateway configured to receive downlink packets from a Serving Gateway (SGW), each downlink packet including a GTP-U header containing a Tunnel Endpoint Identifier (TEID) encoding a virtual node identifier (vNodeId) in bits 24-31. The network connectivity gateway is further configured to extract the vNodeId from the TEID, determine a destination vNode instance based on the extracted vNodeId, and forward the downlink packet to the destination vNode instance.

According to other aspects of the present disclosure, the system may include one or more of the following features. The network connectivity gateway may be further configured to receive uplink packets from the plurality of vNode instances and transmit the uplink packets to the SGW using a single external S1-U IP address. The TEID may further encode a Cell identifier (CellId) in bits 20-23, a User Equipment identifier (UE Id) in bits 8-19, a Radio Bearer Identifier (RBID) in bits 2-7, and a Tunnel type in bits 0-1. The system may further include a Control-Plane Aggregator (CPA) configured to aggregate S1-C control plane traffic from the plurality of vNode instances. The network connectivity gateway may be implemented as a Kubernetes pod. The network connectivity gateway may be further configured to maintain a mapping between internal loopback IP addresses and vNode instances. The network connectivity gateway may be further configured to process GTP-U echo requests and echo responses by encoding and extracting vNodeId from sequence numbers.

According to yet another aspect of the present disclosure, a non-transitory computer-readable medium storing instructions is provided. The instructions, when executed by a processor, cause the processor to receive a downlink GTP-U packet from a Serving Gateway (SGW), the packet including a Tunnel Endpoint Identifier (TEID). The instructions cause the processor to extract a virtual node identifier (vNodeId) from bits 24-31 of the TEID. The instructions cause the processor to identify a destination virtual node (vNode) instance from a plurality of vNode instances based on the extracted vNodeId. The instructions cause the processor to route the downlink GTP-U packet to the identified destination vNode instance.

According to other aspects of the present disclosure, the non-transitory computer-readable medium may include instructions that cause the processor to perform one or more of the following. The instructions may further cause the processor to receive uplink GTP-U packets from the plurality of vNode instances and transmit the uplink packets to the SGW using a shared external S1-U IP address. The instructions may further cause the processor to process GTP-U echo messages by encoding vNodeId in sequence numbers for echo requests and extracting vNodeId from sequence numbers for echo responses.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system architecture for S1-U aggregation in a virtualized baseband unit server, according to aspects of the present disclosure.

FIG. 2 illustrates an alternative system architecture for S1-U aggregation with TEID range allocation, according to aspects of the present disclosure.

FIG. 3 illustrates a TEID encoding structure for S1-U aggregation, according to aspects of the present disclosure.

FIG. 4 illustrates an S1-U aggregation concept between vNode instances and a network connectivity gateway, according to aspects of the present disclosure.

FIG. 5 illustrates a sequence diagram for S1-U aggregation flow, according to aspects of the present disclosure.

FIG. 6 illustrates an uplink GTP-U echo request and response flow, according to aspects of the present disclosure.

FIG. 7 illustrates a network architecture for GTP-U echo handling, according to aspects of the present disclosure.

FIG. 8 illustrates a flowchart of a method for aggregating S1-U interface traffic in a virtualized baseband unit server, according to aspects of the present disclosure.

FIG. 9 illustrates a flowchart of a method for handling uplink traffic in an S1-U aggregation environment, according to aspects of the present disclosure.

FIG. 10 illustrates a flowchart of a method for initializing and binding socket connections in an S1-U aggregation environment, according to aspects of the present disclosure.

FIG. 11 illustrates a flowchart of a method for handling GTP-U echo messages in an S1-U aggregation environment, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

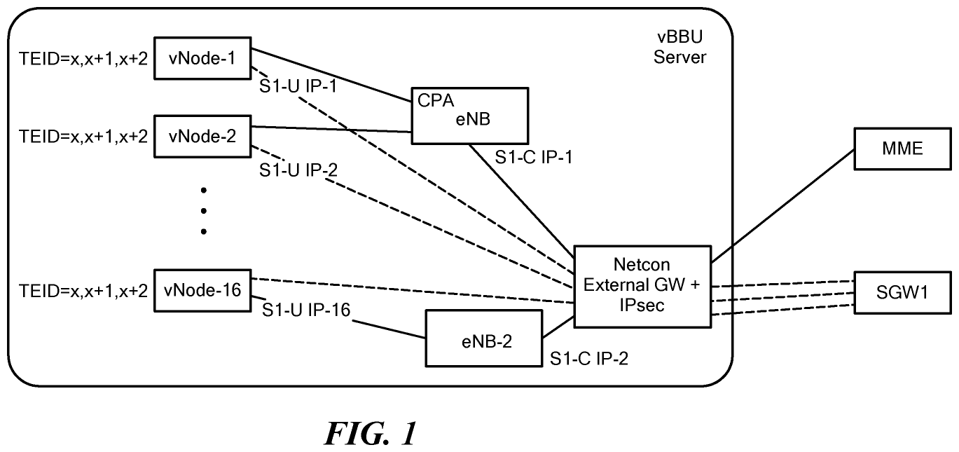

Referring to FIG. 1, a system architecture for S1-U aggregation in a virtualized baseband unit (vBBU) server environment is illustrated. The present disclosure relates to the field of telecommunications, specifically to the aggregation of S1-U interfaces in virtual baseband units (vBBU) within a cellular network. The systems and methods described herein may address the need for efficient handling of multiple IP addresses and the aggregation of control and user plane traffic in a virtualized environment.

In both second-generation (2G) and third-generation (3G) radio access technologies, a Radio Access Network (RAN) aggregation node may be provided with the benefit of reducing the load on the core network. In 2G, this node may be the Base Station Controller (BSC); in 3G, it may be the Radio Network Controller (RNC). Fifth-generation (5G) technology may enable RAN aggregation through the Centralized Unit (CU). However, fourth-generation (4G) technology, as specified by the Third Generation Partnership Project (3GPP), does not include such an aggregation node. The present disclosure provides an aggregation node capable of offering similar advantages for 4G as those provided in 2G, 3G, and 5G.

With continued reference to FIG. 1, the system architecture includes multiple vNode instances, shown as vNode-1, vNode-2, through vNode-16. Each vNode instance may support a single sector of cellular coverage. In some cases, a 4G stack running on each vNode may include Radio Resource Control (RRC), Packet Data Convergence Protocol (PDCP), Medium Access Control (MAC), and lower layers such as the Physical layer (PHY). Multiple vNode instances may be deployed based on the number of carriers, and these instances may run in a single Kubernetes pod.

The vNode instances may connect to a Control-Plane Aggregator (CPA) for S1-C control plane traffic. The CPA may be hosted in the vBBU server and may serve multiple eNBs on the same server. The system may also include a network connectivity gateway (Netcon) that serves as an external gateway with IPsec functionality. The Netcon gateway may connect to core network elements including the Mobility Management Entity (MME) for control plane connectivity and the Serving Gateway (SGW) for user plane connectivity.

In operation, it may be typical for multiple 4G sectors served by one or more virtual baseband units (vBBUs) to be present at a single location. For example, three sectors of cellular radio coverage may be mounted on a pole and pointed in roughly three different directions, providing coverage in all directions from the pole. These three sectors may each be serviced by a single vBBU. Additional carriers may be present at a single location, each requiring its own vBBU. This may result in a scenario where 16 or more IP addresses would be needed for a single pole without aggregation.

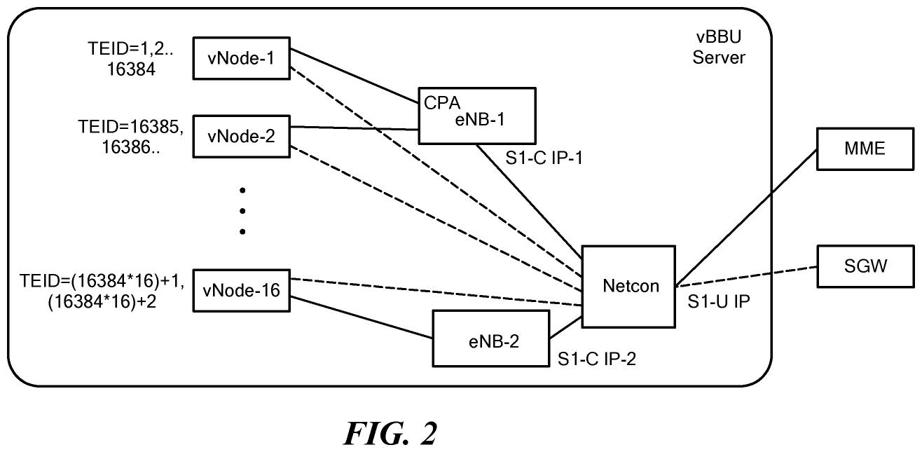

Referring to FIG. 2, an alternative system architecture for S1-U aggregation with TEID range allocation is illustrated. Each vNode instance may be associated with specific TEID ranges. For example, vNode- 1 may be assigned TEID values from 1 to 16,384, vNode-2 may have TEID values from 16,385 onwards, and so forth. The vNode instances may connect to a central Netcon component, which serves as the aggregation gateway.

The system may aggregate both control plane and user plane traffic. Toward the core network, each stack may use an IP to communicate with the Serving Gateway (SGW). Without aggregation, this may result in multiple IPs, up to one IP per virtual container. In some embodiments, the S1-aggregation functionality may be integrated into the vBBU server to aggregate those multiple IPs to create a standard eNB from the perspective of the Evolved Packet Core (EPC).

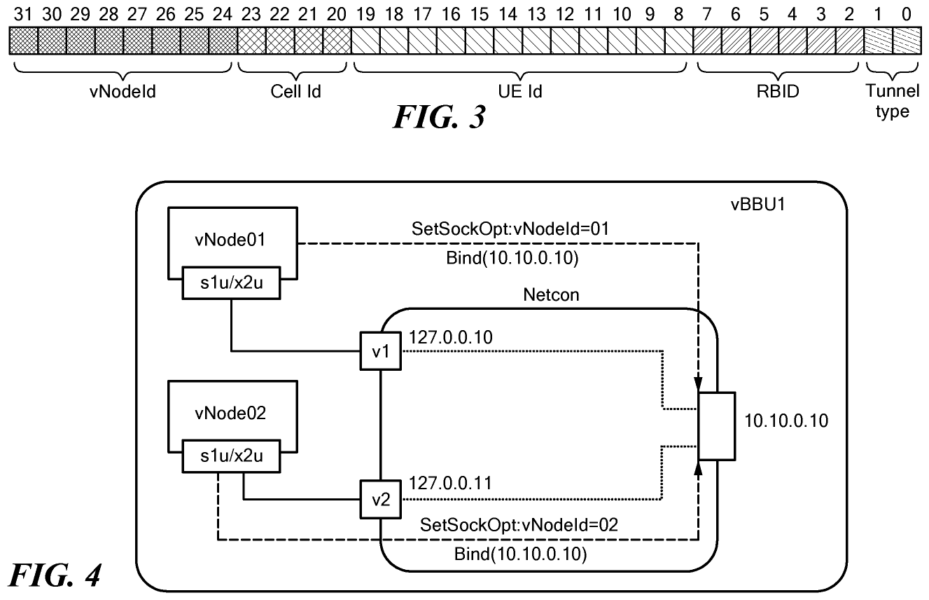

Referring to FIG. 3, a TEID encoding structure for S1-U aggregation is illustrated. The system may multiplex user traffic using tunnel identifiers (TEIDs) on the GTP-U tunnel. The TEID address space may be subdivided across vNode stack instances, with each instance allocated a usable TEID range. There may be 2∧32 TEIDs available. In some embodiments, the Service Management and Orchestration (SMO) platform may allocate these TEIDs across different nodes in the overall operator network, such that each stack instance gets its own ID and each site has an allocated TEID range. In some embodiments, the TEID allocations may be able to be managed using a GUI, configuration file, or other direct access method by the network operator; in other embodiments, the TEID allocations may be managed automatically.

With continued reference to FIG. 3, the 32-bit TEID may be encoded with multiple fields. In some embodiments, the TEID encoding may include: vNodeId in bits 24-31 (8 bits), which identifies the virtual node instance; Cell Id in bits 20-23 (4 bits), which identifies the specific cell; UE Id in bits 8-19 (12 bits), which represents the user equipment identifier; RBID (Radio Bearer ID) in bits 2-7 (6 bits), which identifies the radio bearer; and Tunnel type in bits 0-1 (2 bits). This encoding structure may support up to 256 vNodes (8 bits), 16 cells per vNode (4 bits), 4,096 UEs per cell (12 bits), 64 radio bearer identifiers (6 bits), and 4 tunnel types (2 bits).

In some embodiments, an alternative TEID encoding scheme may allocate 16 bits for the vNodeID, which may allow up to 2≠vNodes in the cluster. Each vNode may possess up to 16 cells. With this encoding, a single cell may serve up to 4,096 UEs and 32 Data Radio Bearer (DRB) IDs. In the original TEID encoding scheme, the 32-bit TEID may be encoded with 8 bits for cell index (cellIdx), 16 bits for UE index (UE Idx), 6 bits for RBID, and 2 bits for Tunnel Type, which may allow 64 K UEs per cell to be served at a vNode. With S1-U IP shared among vNodes, the vNodeIdx may be encoded in the TEID to enable routing.

The modified TEID encoding scheme may enable the system to identify the specific vNode instance from the TEID without inspecting the user packet payload. The Netcon gateway may extract the vNodeId from the most significant bits of the TEID to route downlink traffic to the correct vNode instance, enabling efficient S1-U traffic aggregation across multiple virtual nodes sharing a single external IP address.

The use of the TEID for routing purposes may provide the advantage of making the aggregation mechanism transparent to upstream network nodes. Because the TEID is already present in the GTP-U header and is used by the SGW to identify the tunnel endpoint, the SGW and other core network elements may not require any modification or awareness of the aggregation taking place at the vBBU server. From the perspective of the core network, the aggregated vNode instances may appear as a single eNB with a single S1-U IP address. The SGW may continue to use standard GTP-U procedures, encoding the TEID in downlink packets as it would for any conventional eNB. The Netcon gateway may then leverage the vNodeId embedded within the TEID to perform internal routing without altering the packet structure or requiring additional signaling between the vBBU server and the core network. This transparency may simplify deployment and integration with existing network infrastructure, as no changes to the EPC or SGW or 5GC configuration may be required to support the aggregation functionality.

Referring to FIG. 4, an S1-U aggregation concept between vNode instances and a network connectivity gateway is illustrated. The network connectivity gateway (netcon) may be a virtualized network connectivity gateway. The diagram shows vNode instances (e.g., vNode01 and vNode02) each containing an S1-U/X2-U interface component. Both vNodes may communicate with a central Netcon module through internal loopback IP addresses. For example, vNode01 may be assigned 127.0.0.10 and vNode02 may be assigned 127.0.0.11. While sockets are described for network interaction in the present example, non-sockets-based IP traffic handling may also be used in some embodiments with the presently described aggregation gateway.

Each vNode may perform a SetSockOpt operation to communicate its vNodeId to Netcon. For example, vNode01 may set vNodeId=01 and vNode02 may set vNodeId=02. Both vNodes may execute a Bind operation using the same external IP address (e.g., 10.10.0.10), demonstrating how multiple vNode instances may share a single external S1-U IP address for communication with the core network. The Netcon module may maintain the mapping between the internal loopback addresses and the shared external IP address.

During initialization, Netcon may create a plurality of internal IPs (e.g., 32 internal IPs in the range of 127.0.0.10 to 127.0.0.42) and assign them to a loopback interface. Netcon may receive the vNodeId as part of the vNode name (e.g., S453504X1918642-01-4G) via socket options. Once Netcon receives the vNodeId via VCL APIs (Set socket options), the vNodeId may be stored with the client socket.

When Netcon receives a bind request from a vNode (via external IP), it may internally create the bind with a loopback address (127.0.0.x) and associate the vNode with this loopback address. Netcon may create the external IP to vNodeId mapping upon receiving the bind request.

In some embodiments, a graphical user interface (GUI) may be provided for configuration. As multiple vNodes may aggregate the IP, the GUI may allow multiple vNodes to configure the same GTP-U address.

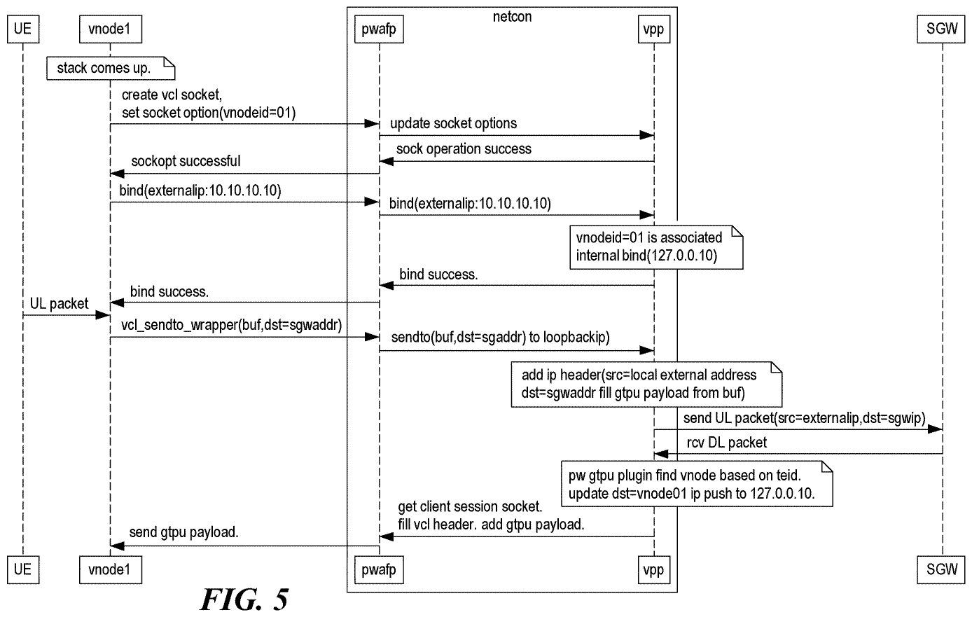

Referring to FIG. 5, a sequence diagram for S1-U aggregation flow is illustrated. The sequence may begin with the stack coming up at a vNode, followed by the creation of a VCL socket and setting of socket options with the vNodeId. The vNode may communicate with a packet processing component (pwafp) to update socket options, which may then confirm socket operation success.

After receiving socket option confirmation, the vNode may perform a bind operation using an external IP address (e.g., 10.10.10.10). The pwafp may process this bind request and associate the vNodeId with an internal bind address (e.g., 127.0.0.10). Upon bind success, the system may be ready to handle user equipment (UE) traffic.

For uplink traffic, when a UE initiates an uplink packet transmission, the vNode may use a vcl_sendto_wrapper with buffer and destination set to the SGW address. This may trigger pwafp to send the data to the loopback interface. A vector packet processing (VPP) component may then add an IP header with source set to the local external address and destination set to the SGW address, filling the GTP-U payload from the buffer. The VPP may send the uplink packet with source set to the external IP and destination set to the SGW IP toward the SGW.

For downlink traffic, when a downlink packet is received from the SGW, the VPP's GTP-U plugin may find the vNode based on the TEID, update the destination to the vNode IP, and push the packet to the appropriate loopback address (e.g., 127.0.0.10). The pwafp may then get the client session socket, fill the VCL header, and add the GTP-U payload before sending the GTP-U payload back to the vNode, which may ultimately deliver it to the UE.

Netcon may receive uplink S1-U UDP packets from vNodes. If IPSec is enabled, the user plane SGW address may be updated at the source and sent to an IPSec module via an uplink IPSec network. Netcon may update the source IP of this packet to the S1-U External IP. If IPSec is disabled, the user plane SGW address may be updated in the source IP and the GTP-U packet may be sent towards the destination SGW network.

For downlink S1-U GTP-U packets (Message Type: T-PDU (0xff)), Netcon may extract the vNodeId from TEID (bits 24-31) of the GTP-U packet and select the vNode S1-U IP address based on the vNodeId. After determining the vNodeId, Netcon may update the destination address of the UDP packet to the vNode IP and forward it to the vNode.

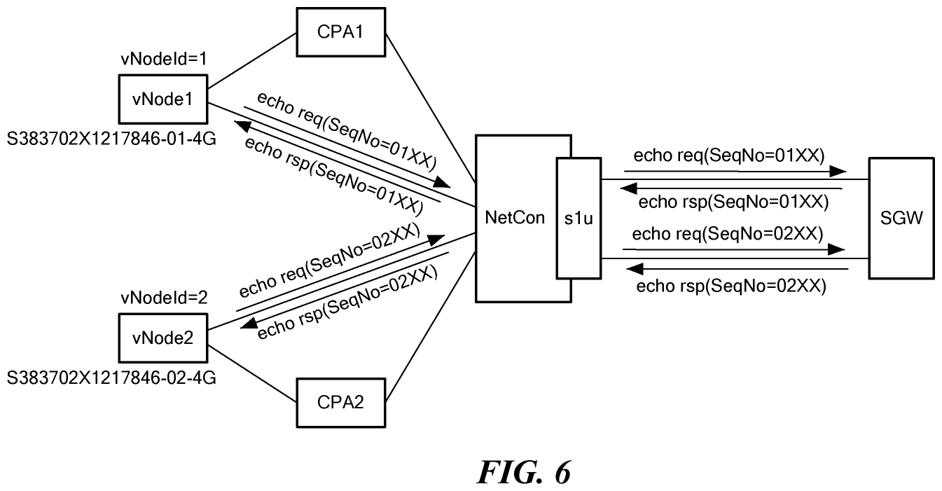

Referring to FIG. 6, an uplink GTP-U echo request and response flow is illustrated. The diagram shows vNode instances (e.g., vNode1 with vNodeId=1 and vNode2 with vNodeId=2) communicating through their respective Control-Plane Aggregators (CPA1 and CPA2). The Netcon component may serve as the central aggregation point, receiving echo requests from both vNodes.

The echo request messages may be shown with sequence numbers encoded to include the vNode identifier. For example, echo_req(SeqNo=01XX) may originate from vNode1 and echo_req(SeqNo=02XX) may originate from vNode2. These requests may flow through Netcon toward the S1-U interface and ultimately to the SGW. The SGW may respond with corresponding echo response messages, echo_rsp(SeqNo=01XX) and echo_rsp(SeqNo=02XX), which may flow back through Netcon.

The Netcon component may extract the vNodeId from the sequence number in the echo response to route the response to the correct originating vNode. This may demonstrate how the sequence number encoding with vNode identifiers enables proper routing of GTP-U echo messages in an aggregated S1-U environment where multiple vNodes share a single external IP address.

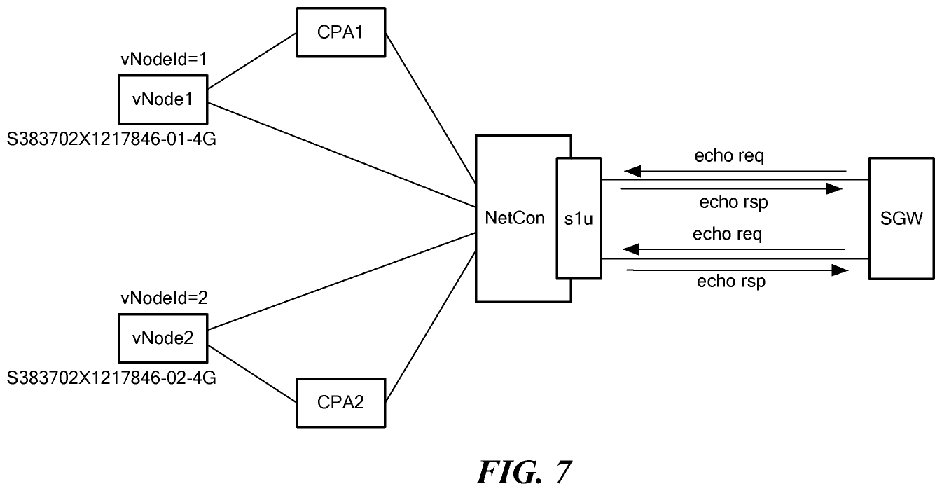

With reference to FIG. 7, a network architecture for GTP-U echo handling is illustrated. The stack may encode the 2-octet sequence number with 1 octet dedicated to the vNode ID and a second octet for the local sequence number. The sequence number may be added in the GTP-U Echo Request towards the SGW. Echo retry mechanisms with current timers may remain the same as standard implementations.

When Netcon receives a GTP-U Echo request from the SGW, a GTP-U Echo response may be sent back to the SGW echoing the sequence number. When Netcon receives a GTP-U Echo response from the SGW, Netcon may extract the vNodeId from the sequence number and forward the same to the destination vNode.

For GTP-U error indication handling, uplink GTP-U error indication from a vNode may be forwarded to the SGW based on the destination SGW IP. For downlink GTP-U error indication from the SGW, the TEID may be checked from the TEID Data I field in the GTP-U header. VPP may extract the vNodeId from the most significant bits and push the error indication to the destination vNode.

For uplink traffic, the stack may use the external GTP-U IP address as the source IP address to send to the SGW. The Netcon pod may configure the S1-U External IP as the GTP-U endpoint IP address. The Netcon pod may maintain the list of vNode IPs associated with the S1-U External IP. For downlink traffic, Netcon may determine the target vNode based on the vNodeId decoded from the TEID.

The stack application may read the vNodeId received from the configuration and use it to encode in the TEID. After GTP-U bind success, the stack may update Netcon about the vNodeId via socket options. The stack may re-encode the TEID by shrinking 16-bit UEIDs into 12 bits, placing the CellId in bits 20-23, and placing the vNodeId (8 bits) in bits 24-31.

In some embodiments, the system may support handover procedures. While sending the Initial Context Setup Response, the S1-U external IP (USER_LOCAL_ADDRESS) may be used along with the DL-GTP TEID. Similarly, while sending the E-RAB Setup Response, E-RAB Modification Indication, Handover Request Acknowledge, or Path Switch Request, the S1-U external IP may be used as the transport layer address along with the GTP-TEID.

The handover procedure may follow standard protocols, with TEIDs allocated by the vNode instances. The SGW may use the assigned TEID, and the Netcon gateway may identify the vNodeId from the TEID without inspecting the user packet. When a session is terminated, the TEIDs may be returned to the unused TEID pool.

In some embodiments, the system may support 5G Non-Standalone (NSA) networks. The approach described herein may be applicable to 5G NSA networks, allowing for the use and reuse of TEIDs by 5G Centralized Units (CUs). An S1 aggregator may provide service for 5G gNBs that require service from a 4G EPC (for example, in non-standalone (NSA) mode).

In some embodiments, the aggregation techniques described herein may be applicable to fifth-generation (5G) networks, including both Non-Standalone (NSA) and Standalone (SA) architectures. In 5G, the radio access network architecture may include Centralized Units (CUs) and Distributed Units (DUs), which may be deployed in virtualized environments similar to the vBBU architecture described herein. The challenge of managing multiple IP addresses in virtualized environments may be equally relevant in 5G deployments, where multiple CU and DU instances may be hosted on a single server or cluster. In 5G, the user plane interface to the core network may be the N3 interface, which connects to the User Plane Function (UPF), analogous to the S1-U interface connecting to the SGW in 4G. An aggregator may aggregate both CU and DU user plane traffic, reducing the number of IP addresses required for communication with the core network. The TEID encoding and routing techniques described herein may be applied similarly to aggregate N3 traffic from multiple CUs and DUs sharing a single external IP address toward the UPF.

In some embodiments, the aggregator may be configured to aggregate both 4G and 5G traffic simultaneously. A single Netcon gateway may handle S1-U traffic from 4G vNode instances and N3 traffic from 5G CU instances, providing a unified aggregation point for multi-generation deployments. This may be particularly advantageous in scenarios where operators deploy both 4G and 5G infrastructure on the same server or cluster, as the aggregator may reduce the total number of external IP addresses required for communication with both the 4G EPC and the 5G core network. As 5G also uses GTP TEIDs, the TEID encoding scheme may be used. In some embodiments it may be extended to distinguish between 4G and 5G vNodes, enabling the aggregator to route packets to the appropriate vNode or CU instance based on the encoded identifiers.

For scalability, multiple sockets may be created within the common node, each handling up to 2.5 Gbps of traffic. This may be achieved by embedding the thread ID and vNode ID in the TEID, in some embodiments in the most significant bits of the TEID. This way, the system may handle higher traffic volumes up to the higher limits of other nodes in the network by distributing the load across multiple sockets, and it may be possible to look at packet headers at a fixed offset for efficiency and without changing the signature of the packet.

In some embodiments, the system may be deployed as a single node cluster based on Kubernetes and Elastic technologies. The Netcon pod may be a Kubernetes pod common to 2G, 4G, and 5G vBBU deployments handling networking, gatewaying and backhaul, IP fastpath and vector packet processing (VPP), and IPsec for the vBBU in various deployments, which may be augmented to provide S1 aggregation. Where the present disclosure mentions the use of virtualization or virtualization technologies, Kubernetes, containerized architectures, or other similar and/or equivalent technologies are contemplated by the inventors.

In some embodiments, there may be support for X2 handover between eNBs and third-party eNBs. Additionally, Multi-Operator Radio Access Network (MORAN) may be supported by the eNB as per specifications, and configuration of cells per operator may be enabled via an Element Management System (EMS).

In some embodiments, S1-U traffic may not be aggregated for vNodes hosted on multiple nodes serving the same eNB ID. The aggregation functionality described herein may be applicable when vNodes are hosted on a single vBBU server.

In some embodiments, a parameter configuration data structure may enable a user to provide configuration of new parameters or changes to existing parameters. The parameters may include one or more of the following fields: GUI display name, description or tooltip, dependencies, GUI tab or category, GUI subcategory, units, range, default value, mandatory (Boolean), and on-the-fly (Boolean). The on-the-fly field may indicate whether a parameter can be changed during runtime without requiring a restart.

In some embodiments, TEID generation may be performed using different methods. Thread ID and vNode ID may be used programmatically to generate the TEID, for example, by using a mapping function or by directly embedding these parameters into the TEID. IPs and TEIDs may be assigned from a TEID range at the time an instance joins the network.

The GTP-U tunnels may use the TEID to identify the vNode instance. The Netcon node may perform a partial lookup of the TEID to determine the vNodeId. As used herein, a partial lookup may refer to examining only a specific portion of the TEID, specifically the most significant bits containing the vNodeId, such as at a fixed offset in the GTP-U header, rather than inspecting the entire packet payload or performing a full table lookup against all possible TEID values. This may enable efficient routing without deep packet inspection. This way, it may route the traffic to the correct instance without inspecting the user packet. The TEID may be embedded with the vNodeId, allowing for efficient routing.

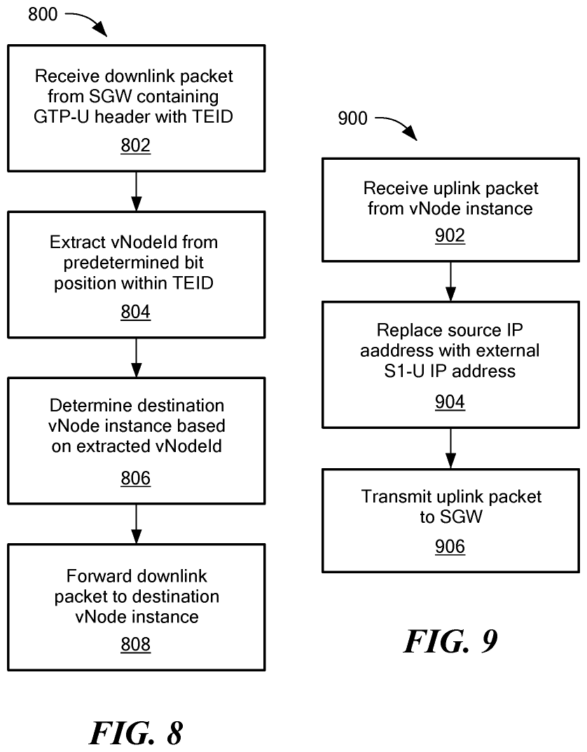

Referring to FIG. 8, a method 800 for aggregating S1-U interface traffic in a virtualized baseband unit (vBBU) server is illustrated. Method 800 includes a step 802 of receiving, at a network connectivity gateway, a downlink packet from a Serving Gateway (SGW), wherein the downlink packet includes a GTP-U header containing a Tunnel Endpoint Identifier (TEID). Method 800 includes a step 804 of extracting a virtual node identifier (vNodeId) from a predetermined bit position within the TEID. Method 800 includes a step 806 of determining, based on the extracted vNodeId, a destination virtual node (vNode) instance from a plurality of vNode instances hosted on the vBBU server. Method 800 includes a step 808 of forwarding the downlink packet to the determined destination vNode instance.

Referring to FIG. 9, a method 900 for handling uplink traffic in an S1-U aggregation environment is illustrated. Method 900 includes a step 902 of receiving, at a network connectivity gateway, an uplink packet from a vNode instance. Method 900 includes a step 904 of replacing a source IP address of the uplink packet with an external S1-U IP address. Method 900 includes a step 906 of transmitting the uplink packet to the SGW.

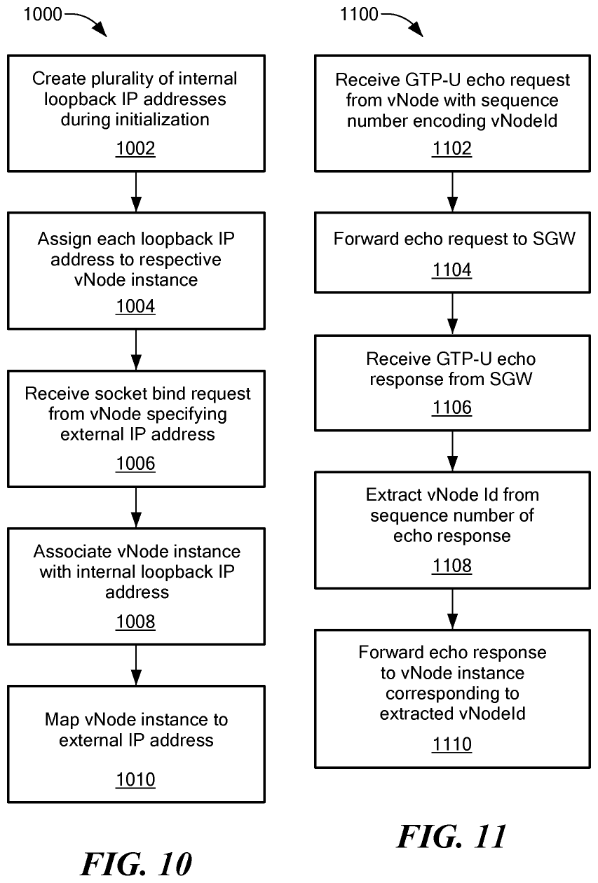

Referring to FIG. 10, a method 1000 for initializing and binding socket connections in an S1-U aggregation environment is illustrated. Method 1000 includes a step 1002 of creating a plurality of internal loopback IP addresses during initialization. Method 1000 includes a step 1004 of assigning each loopback IP address to a respective vNode instance. Method 1000 includes a step 1006 of receiving a socket bind request from a vNode instance specifying an external IP address. Method 1000 includes a step 1008 of associating the vNode instance with an internal loopback IP address. Method 1000 includes a step 1010 of mapping the vNode instance to the external IP address.

Referring to FIG. 11, a method 1100 for handling GTP-U echo messages in an S1-U aggregation environment is illustrated. Method 1100 includes a step 1102 of receiving a GTP-U echo request from a vNode instance, wherein the echo request includes a sequence number encoding the vNodeId. Method 1100 includes a step 1104 of forwarding the echo request to the SGW. Method 1100 includes a step 1106 of receiving a GTP-U echo response from the SGW. Method 1100 includes a step 1108 of extracting the vNodeId from the sequence number of the echo response. Method 1100 includes a step 1110 of forwarding the echo response to the vNode instance corresponding to the extracted vNodeId.

A number of implementations have been described. Nevertheless, it will be understood that various modifications may be made without departing from the spirit and scope of the disclosure. Accordingly, other implementations are within the scope of the following claims.

1. A method for aggregating S1-U interface traffic in a telecommunications network node, the method comprising:
receiving, at a network connectivity gateway, a downlink packet from a user data gateway, wherein the downlink packet includes a GTP-U header containing a Tunnel Endpoint Identifier (TEID);
extracting a virtual node identifier (vNodeId) from a predetermined bit position within the TEID;
determining, based on the extracted vNodeId, a destination virtual node (vNode) instance from a plurality of vNode instances hosted on the telecommunications network node; and
forwarding the downlink packet to the determined destination vNode instance.

2. The method of claim 1, wherein the telecommunications network node comprises a virtualized baseband unit (vBBU) server.

3. The method of claim 1, wherein the user data gateway comprises a Serving Gateway (SGW).

4. The method of claim 1, wherein the network connectivity gateway is implemented as a Kubernetes pod.

5. The method of claim 1, wherein the predetermined bit position comprises bits 24-31 of the TEID.

6. The method of claim 5, wherein the TEID further encodes a Cell identifier (CellId) in bits 20-23, a User Equipment identifier (UE Id) in bits 8-19, a Radio Bearer Identifier (RBID) in bits 2-7, and a Tunnel type in bits 0-1.

7. The method of claim 1, further comprising:
receiving, at the network connectivity gateway, an uplink packet from a vNode instance;
replacing a source IP address of the uplink packet with an external S1-U IP address; and
transmitting the uplink packet to the user data gateway.

8. The method of claim 7, wherein the plurality of vNode instances share a single external S1-U IP address for communication with the user data gateway.

9. The method of claim 1, further comprising:
receiving a GTP-U echo request from a vNode instance, wherein the echo request includes a sequence number encoding the vNodeId; and
forwarding the echo request to the user data gateway.

10. The method of claim 9, further comprising:
receiving a GTP-U echo response from the user data gateway;
extracting the vNodeId from the sequence number of the echo response; and
forwarding the echo response to the vNode instance corresponding to the extracted vNodeId.

11. The method of claim 1, further comprising:
during initialization, creating a plurality of internal loopback IP addresses; and
assigning each loopback IP address to a respective vNode instance.

12. The method of claim 11, further comprising:
receiving a socket bind request from a vNode instance specifying an external IP address; and
associating the vNode instance with an internal loopback IP address while mapping the vNode instance to the external IP address.

13. A system for aggregating S1-U interface traffic, the system comprising:
a virtualized baseband unit (vBBU) server hosting a plurality of virtual node (vNode) instances, each vNode instance configured to support at least one cellular sector; and
a network connectivity gateway executing on the vBBU server, the network connectivity gateway configured to:
receive downlink packets from a Serving Gateway (SGW), each downlink packet including a GTP-U header containing a Tunnel Endpoint Identifier (TEID) encoding a virtual node identifier (vNodeId);
extract the vNodeId from the TEID;
determine a destination vNode instance based on the extracted vNodeId; and
forward the downlink packet to the destination vNode instance.

14. The system of claim 13, wherein the network connectivity gateway is further configured to receive uplink packets from the plurality of vNode instances and transmit the uplink packets to the SGW using a single external S1-U IP address.

15. The system of claim 13, wherein the TEID further encodes the vNodeId in bits 24-31, a Cell identifier (CellId) in bits 20-23, a User Equipment identifier (UE Id) in bits 8-19, a Radio Bearer Identifier (RBID) in bits 2-7, and a Tunnel type in bits 0-1.

16. The system of claim 13, further comprising a Control-Plane Aggregator (CPA) configured to aggregate S1-C control plane traffic from the plurality of vNode instances.

17. The system of claim 13, wherein the network connectivity gateway is implemented as a Kubernetes pod.

18. The system of claim 13, wherein the network connectivity gateway is further configured to maintain a mapping between internal loopback IP addresses and vNode instances.

19. The system of claim 13, wherein the network connectivity gateway is further configured to process GTP-U echo requests and echo responses by encoding and extracting vNodeId from sequence numbers.

20. A non-transitory computer-readable medium storing instructions that, when executed by a processor, cause the processor to:
receive a downlink GTP-U packet from a Serving Gateway (SGW), the packet including a Tunnel Endpoint Identifier (TEID);
extract a virtual node identifier (vNodeId) from bits 24-31 of the TEID;
identify a destination virtual node (vNode) instance from a plurality of vNode instances based on the extracted vNodeId; and
route the downlink GTP-U packet to the identified destination vNode instance.
